(19) United States
(12) Patent Application Publication
(10) Pub. No.: US 2019/0336901 A1
(43) Pub. Date: Nov. 7, 2019

(54) SIDE-DISCHARGE TYPE NONDIRECTIONAL AIR PURIFIER

(71) Applicant: Core Bolt Co., LTD., Gwangju (KR)

(72) Inventor: Young Kwon Kim, Haenam (KR)

(73) Assignee: Core Bolt Co., LTD., Gwangju (KR)

(21) Appl. No.: 15/985,669

(22) Filed: May 21, 2018

(30) Foreign Application Priority Data
May 3, 2018 (KR) 10-2018-0050977

(51) Int. Cl. B01D 46/00; B01D 46/24

(52) U.S. Cl. CPC B01D 46/0043; B01D 46/2403; B01D 2267/40; B01D 2265/06; B01D 46/0024

(57) ABSTRACT

The present invention relates to a side-discharge type nondirectional air purifier including: a housing extended in a vertical direction thereof and having a plurality of discharge holes formed on an outer peripheral surface thereof; a fan seated onto a top end periphery of the housing and adapted to absorb external air and to discharge the absorbed external air toward a bottom surface of the housing; a spiral wing disposed vertically in an internal space of the housing; a perforated board for pressure adjustment disposed outside the spiral wing and having a plurality of air ventilation holes formed piercedly thereon; and a main filter disposed vertically inside the housing in such a manner as to be surroundingly located outside the perforated board.

### CROSS REFERENCE TO RELATED APPLICATION OF THE INVENTION

The present application claims the benefit of Korean Patent Application No. 10-2018-0050977 filed in the Korean Intellectual Property Office on May 3, 2018, the entire contents of which are incorporated herein by reference.

### BACKGROUND OF THE INVENTION

### Field of the Invention

The present invention relates to an air purifier, and more particularly, to a nondirectional air purifier that is capable of lowering a discharge pressure through the formation of discharge holes on an outer peripheral surface of a housing in every direction and achieving low noise through its internal noise reduction structure.

### Background of the Related Art

Fine dust has been increased due to a variety of environmental pollution sources inclusive of increment in the number of vehicles, and accordingly, it greatly lowers a quality of the air people breathe, together with yellow sand in spring.

Because of the fine dust, respiratory diseases occur, and further, since the fine dust is especially harmful to health of the week and the elderly, it is known to them through various media. For many years, recently, degrees of recognition and appreciation of people for the fine dust and the quality of air have been increasingly enlarged.

On a day having a high fine dust concentration, it is actually hard to willingly change the air in a house, and in the state where windows are closed, further, oil mist generated from cooking in the house is circulated indoors to cause the quality of air to be greatly lowered.

Accordingly, air purifiers for cleaning indoor air have been prevailed.

FIGS. 1A to 2B are perspective views showing conventional air purifiers.

The conventional air purifier as shown in FIGS. 1A and 1B has plane filters 20 mounted thereon. The early conventional air purifier is made thin so as to obtain a small volume and is provided with the plane filters so that it sucks air from the front side thereof and discharges the air upwardly.

The conventional air purifier as shown in FIGS. 1A and 1B has the small volume filters 20 so that it has a small contact area with the air, which causes an amount of air filtered for unit time to become small. Accordingly, the conventional air purifier has a structural limitation so that it fails to ensure a sufficient amount of circulating air.

On the other hand, as a fine dust level is raised and thus hazardous to people's health, a need for the improvement in performance of the air purifier has been increased, and accordingly, an air purifier as shown in FIGS. 2A and 2B has been provided so that an amount of circulating air is increased to filter a substantially large amount of air per unit time.

The conventional air purifier as shown in FIGS. 2A and 2B has a cylindrical filter 20, thereby greatly increasing a contact area with air, and introduces the air from four side surfaces to discharge the air upwardly, thereby greatly improving the performance.

According to the conventional air purifier as shown in FIGS. 2A and 2B, a discharge pressure generated upon the upward discharge of air is very high, but a negative pressure for the air introduction is low, so that air circulation is performed in a manner where the air just around the air purifier is sucked, filtered and finally discharged far.

In detail, even the air distant from the air purifier has to be sucked and filtered, but since the negative pressure is not sufficient, an amount of circulating air in the conventional air purifier just is actually smaller than an amount of circulating air suggested on its specification.

Upon cooking indoors, especially, oil mist generated from the kitchen is circulated indoors and is just sucked at a low negative pressure through the sides of the air purifier, so that when it is considered that the air purifier is generally located on a lower position than a position of cookware in the kitchen, that is, on a floor, the oil mist circulating above the air purifier cannot be effectively collected.

If a quality of indoor air is drastically lowered or if there is a user's separate manipulation, the air purifier raises a rotating speed of a fan to forcedly increase an amount of air introduced, and at this time, strange sound occurs upon the rotation of the fan, which gives many inconveniences in real use.

However, most of air purifiers temporarily rotate the fan to a high speed only when the rotation of the fan to the high speed is required, thereby purifying the indoor air within a short period of time.

### SUMMARY OF THE INVENTION

Accordingly, the present invention has been made in view of the above-mentioned problems occurring in the prior art, and it is an object of the present invention to provide a nondirectional air purifier that is capable of generating a high negative pressure from a top end periphery thereof to forcedly suck air distant therefrom and capable of greatly lowering a discharge pressure so that an air flow discharged is not recognized by a user.

It is another object of the present invention to provide a nondirectional air purifier that is capable of extending a conveying path of an air flow introduced thereinto in consideration of the generation of noise from a discharge surface of a fan, so that while the fan is rotating to a high speed, low noise is realized through double mechanism of noise blocking of soundproof walls and sound absorbing of a filter.

To accomplish the above-mentioned objects, according to the present invention, there is provided a side-discharge type nondirectional air purifier including: a housing extended in a vertical direction thereof and having a plurality of discharge holes formed on an outer peripheral surface thereof; a fan seated onto a top end periphery of the housing and adapted to absorb external air and to discharge the absorbed external air toward a bottom surface of the housing; a spiral wing disposed vertically in an internal space of the housing; a perforated board for pressure adjustment disposed outside the spiral wing and having a plurality of air ventilation holes formed piercedly thereon; and a main filter disposed vertically inside the housing in such a manner as to be surroundingly located outside the perforated board.

According to the present invention, desirably, the perforated board has a shape of a cylinder open on top and bottom ends thereof, and a percentage of the air ventilation holes per unit area of the perforated board becomes increased as the air ventilation holes are distant from the fan, so that an amount of air flow introduced into the main filter can be constantly maintained according to sections of the perforated board.

According to the present invention, desirably, a percentage of the air ventilation holes on the unit area of the uppermost end periphery of the perforated board is 15 to 25% and a percentage of the air ventilation holes on the unit area of the lowermost end periphery of the perforated board is 75 to 85%.

According to the present invention, desirably, the side-discharge type nondirectional air purifier further includes a pipe-shaped vertical pillar vertically passing through a center of the spiral wing.

According to the present invention, desirably, a space formed by an outer peripheral surface of the vertical pillar and an inner peripheral surface of the perforated board is generally filled with the spiral wing, and in detail, a spiral outermost surface of the spiral wing comes into contact with the inner peripheral surface of the perforated board.

According to the present invention, desirably, the fan is coupled to a controller for controlling the fan according to a user's manipulation, setting, or the application of an operating or stopping signal and to a power line extended downwardly therefrom, so that they constitute a top end fan assembly.

According to the present invention, desirably, the top end fan assembly is separably fastened to the housing and the power line passes through the inside of the vertical pillar in such a manner as to be exposed to the outside through one side of an underside of the housing.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIGS. 1A and 1B are perspective views showing a conventional air purifier having plane filters;

FIGS. 2A and 2B are perspective views showing another conventional air purifier having a cylindrical filter;

FIG. 3 is a perspective view showing an outer shape of an air purifier according to the present invention;

FIG. 4 is an exploded perspective view showing parts of the air purifier of FIG. 3;

FIG. 5 is a perspective view showing another example of a spiral wing in the air purifier according to the present invention;

FIG. 6 is a perspective view showing a perforated board for pressure adjustment in the air purifier according to the present invention;

FIG. 7 is a perspective view showing connection relations of the parts of the air purifier according to the present invention;

FIG. 8 is a bottom view showing a structure wherein a power line is exposed to the outside via the underside of a housing in the air purifier according to the present invention; and

FIGS. 9 and 10 are sectional views showing air flow introduction and discharge directions and the principle of noise reduction attainment in the air purifier according to the present invention.

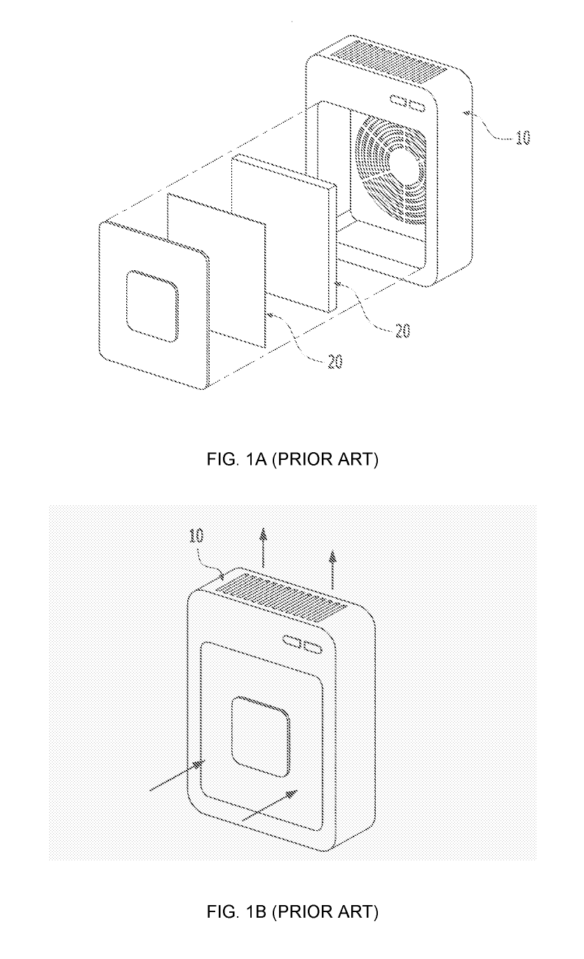

### DETAILED DESCRIPTION OF THE PREFERRED EMBODIMENTS

Now, an explanation on an air purifier according to the present invention will be given with reference to the attached drawings wherein the corresponding parts in the embodiments of the present invention are indicated by corresponding reference numerals.

In the description or claims, when it is said that one portion is described as “includes” any component, one element further may include other components unless no specific description is suggested.

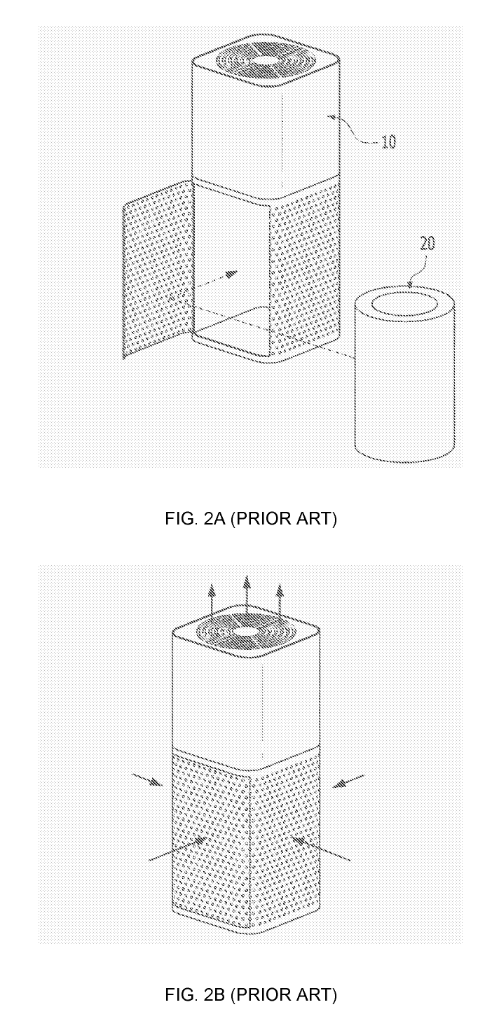

Like the conventional air purifier as shown in FIGS. 2a and 2b, an air purifier according to the present invention is elongated in a longitudinal direction and has hollow cylindrical filters.

Unlike the conventional air purifier, however, the air purifier according to the present invention is configured to have a fan located in an opposite direction to the direction of the fan in the conventional air purifier, to have a structure of reducing noise in an interior thereof, and to allow discharge holes to be kept at a low pressure, thereby attaining low noise and nondirectionality.

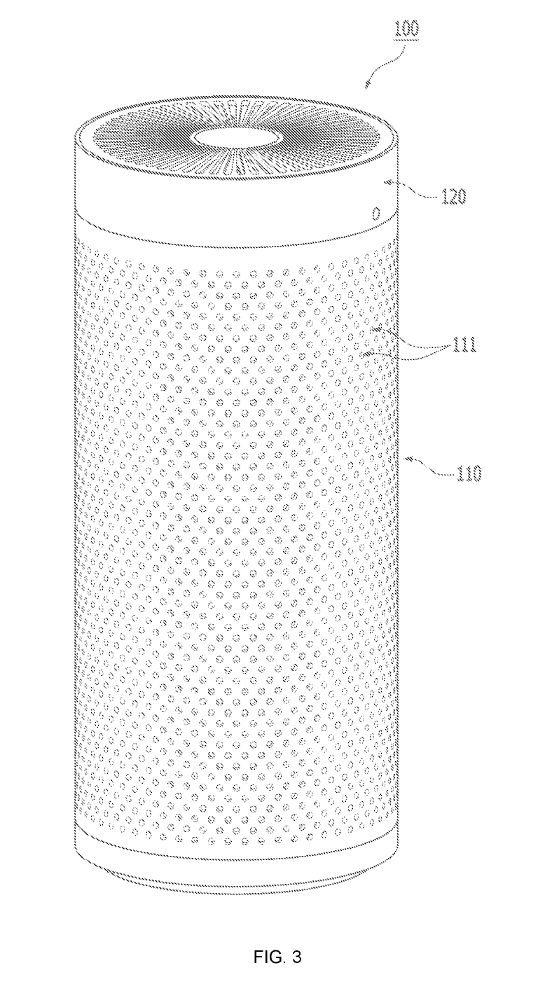

FIG. 3 is a perspective view showing an outer shape of an air purifier 100 according to the present invention.

The air purifier 100 according to the present invention includes a housing 110 having a plurality of discharge holes 110 formed piercedly thereon and a top end fan assembly 120 separably seated onto a top end periphery of the housing 110.

The top end fan assembly 120 sucks external air and discharges the external air toward the bottom surface of the housing 110, which will be discussed later. In detail, while the external air is being lowered in pressure through filtering in the interior of the housing 110, it is discharged through the plurality of discharge holes 110.

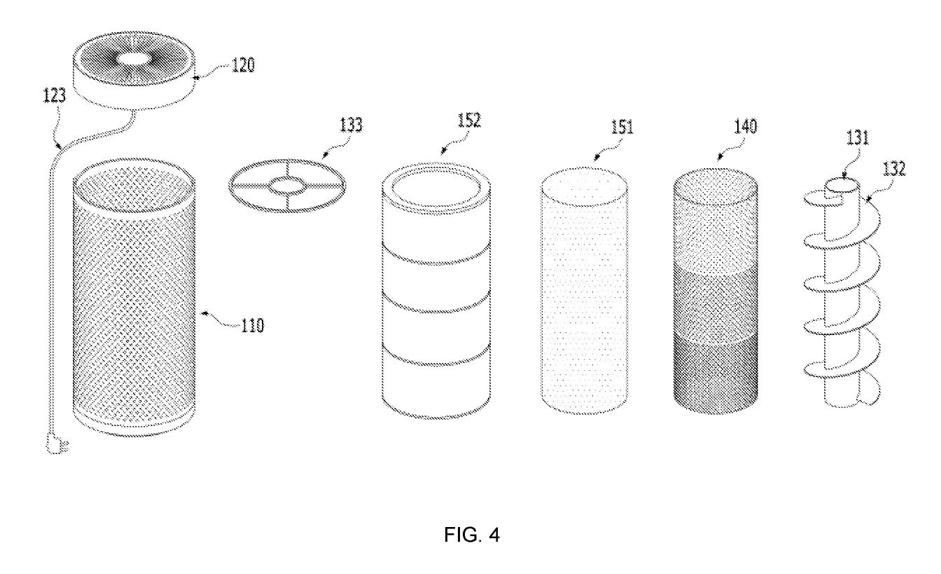

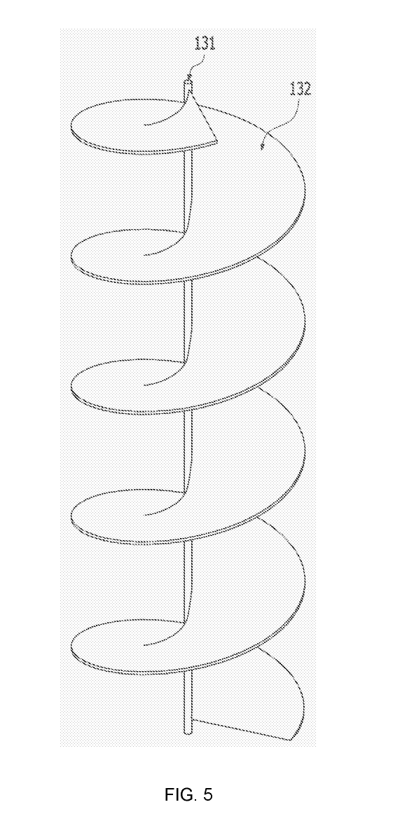

FIG. 4 is an exploded perspective view showing parts of the air purifier of FIG. 3, and FIG. 5 is a perspective view showing another example of a spiral wing in the air purifier according to the present invention.

As shown in FIG. 4, the air purifier 100 according to the present invention includes the housing 110, the top end fan assembly 120, a main filter 152, a dust filter 151, a spiral wing 132, a spiral wing fixing gasket 133, and a perforated board 140 for pressure adjustment.

The housing 110 is desirably made of a synthetic resin and has a shape of a cylinder open on top end portion thereof and hollow in the interior thereof.

On the other hand, the housing 110 has the plurality of discharge holes 111 formed piercedly on the outer peripheral surface thereof. Desirably, the discharge holes 111 are formed to a height corresponding to heights of the main filter 152 and the perforated board 140 for pressure adjustment.

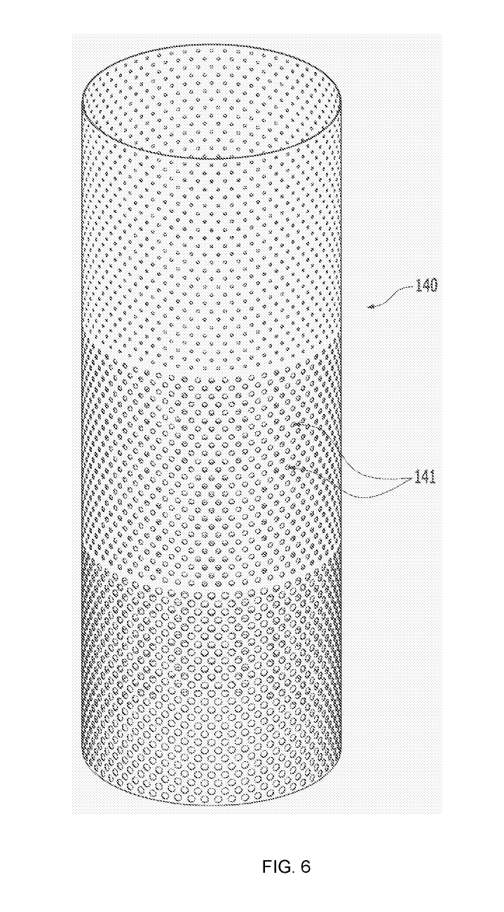

FIG. 6 is a perspective view showing the perforated board 140 for pressure adjustment in the air purifier according to the present invention.

As shown in FIG. 6, the perforated board 140 for pressure adjustment is made of a metal or synthetic resin and has a shape of a cylinder open on top and bottom thereof.

The perforated board 140 for pressure adjustment has a plurality of air ventilation holes 141 formed piercedly on the outer peripheral surface thereof. At this time, a percentage of areas open by the air ventilation holes 141 is varied according to sections of the perforated board 140 for pressure adjustment.

As appreciated from FIG. 6, the sizes of the air ventilation holes 141 are small on the upper end periphery of the perforated board 140 for pressure adjustment, but they become large toward the lower end periphery of the perforated board 140 for pressure adjustment.

In detail, the percentage occupied by the air ventilation holes 141 on the unit area of the perforated board 140 for pressure adjustment becomes large toward the lower end periphery of the perforated board 140 for pressure adjustment from the upper end periphery thereof.

To do this, as shown in FIG. 6, the sizes of the air ventilation holes 141 are varied according to the sections of the perforated board 140 for pressure adjustment. Otherwise, while the sizes of the air ventilation holes 141 are being constant, the number of air ventilation holes 141 is varied according to the sections of the perforated board 140 for pressure adjustment. Further, the sizes or shapes of air ventilation holes 141 and the number of air ventilation holes 141 per unit area are all varied.

As a result, an air flow can be supplied constantly over the entire section of the main filter 152, which will be discussed later.

As a degree of pressure drop by section of the air flow discharged from a fan 121 as will be discussed later is varied according to the performance of the fan 121 or the shape of the spiral wing 132, the percentage occupied by the air ventilation holes 141 on the unit area of the perforated board 140 for pressure adjustment is somewhat varied. In detail, through experiments, if the percentage of the air ventilation holes 141 on the unit area of the uppermost end periphery of the perforated board 140 for pressure adjustment is 15 to 25%, and if, while the percentage of the air ventilation holes 141 is being increased toward the lower end periphery thereof, the percentage of the air ventilation holes 141 on the unit area of the lowermost end periphery of the perforated board 140 for pressure adjustment is 75 to 85%, a constant amount of air flow is supplied to the entire section of the main filter 152.

In case of some of conventional air purifiers, a portion of filter is first closed so that a life span of the filter is early expired, but according to the present invention, a constant amount of air flow is supplied to the entire section of the main filter 152, thereby optimizing the life span of the main filter 152.

As shown in FIG. 4, the top end fan assembly 120 is seated onto the top end periphery of the housing 110 and is simply fastened thereto. Desirably, the top end fan assembly 120 generally has the same horizontal section as the housing 110.

In the state where the top end fan assembly 120 is fastenedly seated onto the top end periphery of the housing 110, accordingly, the air purifier 100 according to the present invention has the general cylindrical shape.

The spiral wing 132 is spirally structured and is elongated vertically. Desirably, as shown in FIG. 4, the spiral wing 132 spirally protrudes from an outer peripheral surface of a vertical pillar 131 open on top and bottom thereof and hollow in an interior thereof.

So as to ensure a sufficient amount of air flow, at this time, a volume occupied by the vertical pillar 131 is desirably minimized.

To do this, a sectional area of the hollow interior of the vertical pillar 131 is minimized, and otherwise, as shown in FIG. 5, the vertical pillar 131 is provided without being hollow in an interior thereof. Further, only the spiral wing 132 may be provided without having any vertical pillar 131.

As shown in FIG. 4, the air purifier 100 according to the present invention is simply disassembled or assembled in a reverse order to each other.

First, the main filter 152 is inserted into the housing 110, and the dust filter 151 and the perforated board 140 for pressure adjustment are inserted sequentially into the main filter 152.

Next, the spiral wing 132 is inserted into the perforated board 140 for pressure adjustment, and after the spiral wing fixing gasket 133 is fitted to a top end periphery of the spring wing 132, the top end fan assembly 120 is seated onto the top end periphery of the housing 110, thereby finishing the assembling of the air purifier 100 according to the present invention.

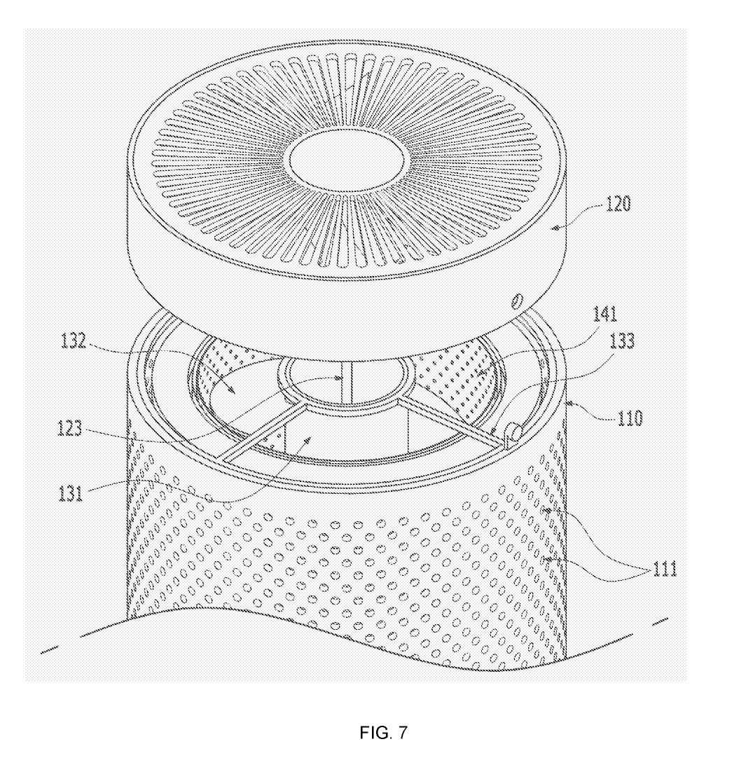

FIG. 7 is a perspective view showing connection relations of the parts of the air purifier 100 according to the present invention.

According to the present invention, as shown in FIG. 7, it can be appreciated that the vertical pillar 131 is located at the center of the interior of the air purifier 100, and next, the spiral wing 132, the perforated board 140 for pressure adjustment, the dust filter 151, the main filter 152, and the housing 110 are fitted laminatedly to one another in the above order.

On the other hand, the top end fan assembly 120 has a power line 123 extended from an underside thereof to apply power to the fan 121 and a circuit, and upon assembling, the power line 123 is put into the hollow interior of the vertical pillar 131.

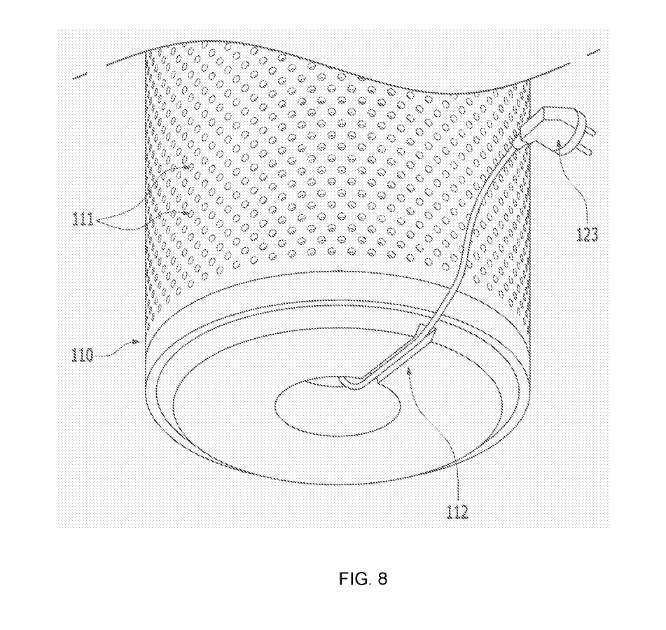

FIG. 8 is a bottom view showing a structure wherein the power line 123 is exposed to the outside via the underside of the housing 110 in the air purifier according to the present invention.

As shown in FIG. 8, the housing 110 is open on the center of the underside surface thereof in such a manner as to communicate to the hollow portion of the vertical pillar 131, and accordingly, the power line 123 is exposed to the outside through the open portion on the center of the underside surface of the housing 110.

On the other hand, the housing 110 has a line communication groove 112 formed concavely on one side of the underside thereof so as to draw the power line 123 outwardly therefrom. Accordingly, the power line 123 is fitted to the line communication groove 112 and is thus exposed to the outside from the housing 110.

The air purifier 100 according to the present invention is simply disassembled in the reverse order to the above-mentioned order, and since a motor and a circuit are disposed only on the top end fan assembly 120, other parts may be simply shaken or washed off. In the conventional air purifiers, just a portion of a cover is removed so as to exchange a filter with new one, so that it is structurally hard to sweep the dust accumulated on the interior of the air purifier. Further, the circuit or fan is assembled to the air purifier in such a manner as to be not separated therefrom, so that it is impossible to perform washing for the air purifier. Contrarily, the air purifier according to the present invention is simply disassembled, washed, dried, and finally re-assembled, so that it is structurally possible to keep a clean state.

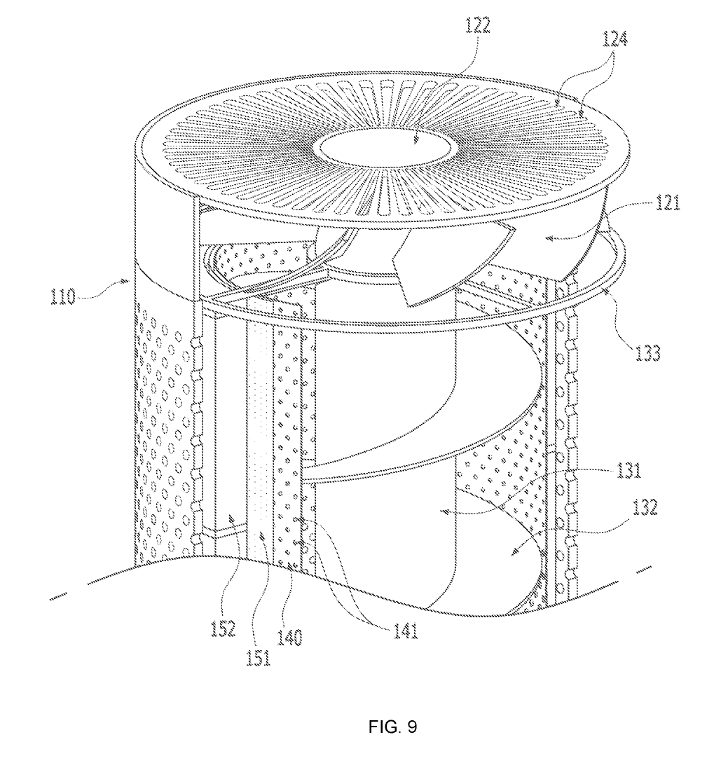

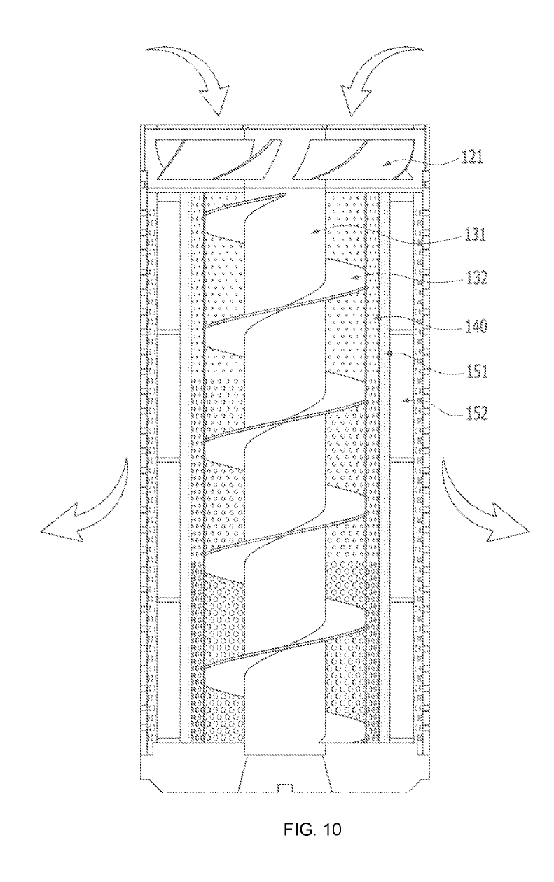

FIGS. 9 and 10 are sectional views showing air flow introduction and discharge directions and the principle of noise reduction attainment in the air purifier according to the present invention.

The top end fan assembly 120 has the fan 121 disposed on the underside of a top cover thereof and a controller 122 disposed on the underside of the center of the top cover. The controller 122 has the motor and the circuit for controlling the fan 121 according to a user's manipulation and further includes a wireless communication adapter like Zigbee or Wifi in cooperative operation with IoT platform.

The top end fan assembly 120 has a control panel disposed exposedly to the outside on the top cover thereof to display states of the air purifier 100 or to control operations of the air purifier 100 and a plurality of introduction holes 124 formed outside the control panel on the top cover thereof.

Through the rotation of the fan 121, external air is introduced through the introduction holes 124 formed on the top cover of the top end fan assembly 120 into the air purifier 100.

A center portion of the fan 121 is closed by the vertical pillar 131, and the undersides of blades of the fan 121 are located toward a space between the vertical pillar 131 and the perforated board 140 for pressure adjustment.

Accordingly, the air flow introduced into the air purifier 100 is discharged through the space between the vertical pillar 131 and the perforated board 140 for pressure adjustment.

On the other hand, the space between the vertical pillar 131 and the perforated board 140 for pressure adjustment is filled with the spiral wing 132, so that the introduced air flow is not linearly conveyed to the lower portion of the housing 110, but is spirally conveyed thereto along the spiral wing 132.

In detail, as shown in FIG. 10, while the introduced air flow above the fan 121 is being conveyed to the lower portion of the housing 110 along the spiral wing 132, it is discharged to the outside of the housing 110.

If there is no perforated board 140 for pressure adjustment, while the air flow is being conveyed along the spiral wing 132, it is greatly decreased in pressure. In detail, the air flow has a high pressure on the top end periphery of the spiral wing 132, but it has a relatively low pressure when if it reaches the bottom end periphery of the spiral wing 132.

By the way, as mentioned above, the perforated board 140 for pressure adjustment is configured to have the percentage of the air ventilation holes 141 on the unit area thereof increased toward the lower end periphery thereof from the upper end periphery thereof, so that the high pressure air flow on the top end periphery of the spiral wing 132 is not completely discharged through the air ventilation holes 141 and is thus conveyed to the lower portion of the housing 110, while being kept to a given pressure.

The air flow becomes low in pressure when it reaches the bottom end periphery of the spiral wing 132, but the percentage of the air ventilation holes 141 of the perforated board 140 for pressure adjustment is increased, so that the distribution of air flow passing through the air ventilation holes 141 of the perforated board 140 for pressure adjustment become generally constant.

In detail, the air flow can be constantly kept irrespective of sections of the air flow introduced into the dust filter 151 and the main filter 152 through the perforated board 140 for pressure adjustment.

The air filtered through the dust filter 151 and the main filter 152 is discharged to the outside through the discharge holes 111 formed on the outer peripheral surface of the housing 110.

At this time, an area of the discharge holes 111 is substantially larger than an area of the introduction holes 124 of the top end fan assembly 120, and accordingly, the air can be kept to a low discharge pressure.

In detail, even though the fan 121 rotates at a high speed to generate a high pressure air flow, the air can be kept to a remarkably low discharge pressure, and accordingly, it is possible to perform nondirectional discharge, while an amount of circulating indoor air is being sufficiently kept to a high level.

In case of the conventional air purifiers, air is directly discharged through the fan to cause a substantially large amount of air flow to be felt by users in front of the fan, and especially, if the fan rotates to a high speed, the amount of air flow is almost similar to the wind from an electric fan, thereby giving many inconveniences to the users.

According to the present invention, contrarily, a discharge pressure is substantially lowered, and accordingly, the discharge of air flow through the discharge holes 111 is not felt by a user, thereby removing inconveniences caused by the air flow discharged from the air purifier 100.

On the other hand, the performance of the air purifier almost depends upon an amount of circulating air, and so as to increase the amount of circulating air, the air purifier is manufactured to a large size or provided with a high performance fan rotating to high RPM.

If it is desired that the size of air purifier is not increased, the rotating speed of the fan should be increased, but in this case, a lot of noise is caused, so that since the air purifier is always used, such noise gives many inconveniences in use to users.

The noise is generated not from the introduction side of the fan, but from the discharge side of the fan, and according to the present invention, the noise is generated when the air flow is discharged from the underside of the fan 121 to the lower portion of the housing 110.

By the way, the air flow is conveyed along the spiral wing 123, and accordingly, the conveying distance of the air flow becomes extended. At this time, the spiral wing 132 and the perforated board 140 for pressure adjustment serve as soundproof walls, and accordingly, while the air flow is being conveyed over a relatively long conveying distance, most of noise disappears.

In addition, the air flow discharged through the air ventilation holes 141 of the perforated board 140 for pressure adjustment passes through the main filter 152, and in this case, the main filter 152 serves as a sound absorbing material, so that the noise is absorbedly removed one more time.

The main filter 152 is made of a material having generally good ventilation capability and low density, and accordingly, it absorbs wavelengths of sound, thereby serving as the sound absorbing material. Of course, first, the main filter 152 has to have high dust collection performance, but it may be made of a material that is very adequate for a sound absorbing material, such as urethane, synthetic fiber or the like.

Through such a double soundproof structure wherein the spiral wing 132 and the perforated board 140 for pressure adjustment serve as the soundproof walls over the entire section of the conveying path of the air flow and the main filter 152 serves as the sound absorbing material, accordingly, the low noise level can be kept even though the fan 121 rotates to a high speed.

According to the present invention, even if the air purifier is not made large, it can ensure a sufficient amount of circulating air, and further, the air purifier can suppress the noise generated from the discharge surface of the fan 121 through the double soundproof structure, thereby removing inconveniences in use caused by the increment of noise.

As described above, the air purifier according to the present invention can minimize the noise generated from the front surface of the fan through noise reduction effects of the spiral wing and the filter, while maximizing an amount of circulating air through the rotation of the fan to high RPM, thereby making it possible to operate at low noise.

Particularly, the air purifier according to the present invention can discharge air flow in every direction through the side periphery of the housing, and the discharge area of the air flow is remarkably larger than the introduction area of the air flow to allow the discharge pressure to be decreased, so that it is possible to perform nondirectional indoor air circulation.

In addition, the air purifier according to the present invention can be simply disassembled through the separation of the top end fan assembly, so that the housing and the perforated board for pressure adjustment can be easily washed.

Further, the air purifier according to the present invention can maintain the discharge pressure constantly irrespective of a distance from the fan, thereby overcoming the shortage of life span due to the partial closing of the filter and further increasing the exchange period of the filter.

On the other hand, the air purifier according to the present invention can make use of the cylindrical filters having substantially larger filtering areas than the plane filters, thereby still providing the advantages of the conventional vertical air purifiers having the cylindrical filters.

Accordingly, the present invention is applicable to technical fields related to air purifiers.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A side-discharge type nondirectional air purifier comprising:
a housing extended in a vertical direction thereof and having a plurality of discharge holes formed on an outer peripheral surface thereof;
a fan seated onto a top end periphery of the housing and adapted to absorb external air and to discharge the absorbed external air toward a bottom surface of the housing;
a spiral wing disposed vertically in an internal space of the housing;
a perforated board for pressure adjustment disposed outside the spiral wing and having a plurality of air ventilation holes formed piercedly thereon; and
a main filter disposed vertically inside the housing in such a manner as to be surroundingly located outside the perforated board.

2. The side-discharge type nondirectional air purifier according to claim 1, wherein the perforated board has a shape of a pipe on at least a portion of a section thereof and a percentage of the air ventilation holes per unit area of the perforated board becomes increased as the air ventilation holes are distant from the fan.

3. The side-discharge type nondirectional air purifier according to claim 2, wherein a percentage of the air ventilation holes on the unit area of the uppermost end periphery of the perforated board is 15 to 25% and a percentage of the air ventilation holes on the unit area of the lowermost end periphery of the perforated board is 75 to 85%.

4. The side-discharge type nondirectional air purifier according to claim 2, further comprising a pipe-shaped vertical pillar vertically passing through a center of the spiral wing, at least a portion of a section of the spiral wing coming into contact with an outer peripheral surface of the vertical pillar and an inner peripheral surface of the perforated board.

5. The side-discharge type nondirectional air purifier according to claim 2, wherein the fan is coupled to a controller for controlling the fan and a power line to which power is applied from the outside so as to constitute a top end fan assembly, the top end fan assembly being separably fastened to the housing and the power line passing through the inside of the vertical pillar in such a manner as to be exposed to the outside through one side of an underside of the housing.

6. The side-discharge type nondirectional air purifier according to claim 2, further comprising a thin type dust filter disposed between the perforated board and the main filter.
